(19) United States
(12) Patent Application Publication
(10) Pub. No.: US 2011/0119583 A1
(43) Pub. Date: May 19, 2011

(54) Module-Based Process for Importing Media Files

(75) Inventors: Greg Gilley, Los Altos, CA (US); Mark Lee Kawano, San Mateo, CA (US); Daniel O'Brien Schimpf, Palo Alto, CA (US)

(73) Assignee: APPLE INC., Cupertino, CA (US)

(21) Appl. No.: 12/832,894

(22) Filed: Jul. 8, 2010

Related U.S. Application Data
(60) Provisional application No. 61/261,711, filed on Nov. 16, 2009.

(51) Int. Cl. G06F 3/00

(52) U.S. Cl. 715/716

(57) ABSTRACT

Among other things, methods, systems and computer program products are disclosed for manipulating media using software executing on a computer system, e.g., by presenting a user interface for the media manipulation software application, the user interface including an import tool configured to facilitate importation of one or more items of media content into the media manipulation software application, the import tool having a plurality of modules, each module representing a different aspect of an importation process; receiving input specifying a subset of the plurality of modules, each module in the specified subset to be displayed to the user and to be used in a subsequent importation process; displaying to the user the modules from the specified subset while hiding the remaining modules from the user; and importing one or more items of media content using the displayed modules.

### PRIORITY CLAIM AND RELATED APPLICATIONS

This patent document claims priority from U.S. Provisional Application No. 61/261,711 entitled “Module-based Process for Importing Media Files” and filed Nov. 16, 2009, which is incorporated by reference as part of the disclosure of this document.

### BACKGROUND

This application relates to importing items of digital media files, for example, digital still media files and/or digital video image files, into a software application such as image editing application or other media manipulation application.

Many computer systems provide application software that enables users to manipulate (for example, view, edit, or otherwise access) digital content, for example, digital media items such as digital images, video, audio, data files, and the like. To become available to the application software, and thus accessible by a user of the application, often the items of digital content are imported into the application, e.g., by copying each digital content item to a memory location associated with the application and making a corresponding entry for each imported item in a database or other data structure maintained by the application.

Digital content items, typically stored as individual media files, can be imported into an application from various different sources such as from a media device (e.g., a digital camera or video recorder), from a folder on the same computer system on which the application is executing, and/or from a remote network location In some cases, adjustments to the media files can be made as part of the importation process.

### SUMMARY

Methods, systems and computer program products are described for importing digital media into a software application. Implementations can optionally include one or more of the features described below.

In one aspect, in general, importing digital media into a software application may involve presenting a user interface for the media manipulation software application, the user interface including an import tool configured to facilitate importation of one or more items of media content into the media manipulation software application, the import tool having a plurality of modules, each module representing a different aspect of an importation process; receiving input (e.g., from a user or an auto-detection software process) specifying a subset of the plurality of modules, each module in the specified subset to be displayed to the user and to be used in a subsequent importation process; displaying to the user the modules from the specified subset while hiding the remaining modules from the user; and importing one or more items of media content using the displayed modules.

The media may include digital still images and/or digital video, and digital audio. The modules may be arranged in an order-dependent or an order-independent manner corresponding to operations to be performed on the media as part of the import process. The modules may be arranged vertically wherein a topmost module corresponds to a start of an importation pipeline and a bottommost module corresponds to an end of the importation pipeline. For example, the modules may be displayed as vertically-stacked bricks along an edge of the user interface.

Each module may correspond to one or more importation parameters. The modules may include or more of a file information module for displaying information about media files, including file name, file date, file size and media dimensions, a library module for specifying the source, destination and handling of imported media files, a rename files module for controlling naming conventions of media files, including one or both of file name prefixes and counters, for creating custom names for media files, a time zone module for specifying time zones associated with the media creation location or importation location or both, a metadata presets module for specifying fields used in associating metadata with each media file imported, including one or more of captions, keywords, image geographic source, copyright notice and credits, an adjustment presets module for applying media adjustments including one or more of black and white conversions, contrast, cross-processing, tinting, cropping, and high-key, a file types module for specifying which media file types to include or exclude during the importation process, a RAW+JPEG pairs module that provides one or more options for importing the RAW+JPEG pairs, an actions module for designating a specified macro to run during the importation process, and/or a backup location module for specifying parameters used in automatically copying media files to designated locations.

In an implementation, one or more modules can be displayed and used automatically without requiring further user input. Optionally, the user can be enabled to specify one or more customized modules to be displayed and used in the importation process. Alternatively, or in addition, user specified modules may be downloaded from a network location corresponding to a third party developer. Optionally, the user may be enabled to selectively change an order of the modules.

In another aspect, a system that facilitates the importation of media items into a software application may include a computer system having a processor, memory and input/output functionality. The system may further include a media manipulation application configured to execute on the computer system and further configured to facilitate importation of selected media. The media manipulation application may include a user interface that includes an import tool configured to facilitate importation of one or more items of media content into the media manipulation application, the import tool having a plurality of modules, each module representing a different aspect of an importation process; a module selection unit to select the modules to be used in the importation process; a user input unit to communicate with the media manipulation application, wherein the user input unit is configured to receive a selection of at least one of the modules and a selection of at least one of the available media; and a display unit to communicate with the media manipulation application, wherein the display unit is configured to display the media selected for the importation process and the modules selected for the importation process based on the received selection.

The subject matter described in this specification can potentially provide one or more advantages. For example, the import tool allows the user to display (and thus use) only those modules of interest (e.g., to be used in the importation process) and to hide (and thus not use) the remaining modules. Further, the modules are compartmentalized, providing parameters organized by functionality, each module representing a different aspect of the importation process.

In another example, by displaying the list of modules in the order they will be performed, the GUI can provide a visual import pipeline. The user can quickly see all of the sequential steps and operations that make up the importation process.

As another example, managing RAW+JPEG pairs as described can provide various camera support functionality. By importing the JPEG files of the corresponding pairs first, the images can be imported faster than importing both file types. Because the JPEG files are smaller in size, due to their compressed nature, JPEG files typically are easier to adjust. Any adjustments applied to the JPEG files can be automatically attributed or associated with the RAW files of the corresponding pairs. Thus, a user can import one of the two image files from each corresponding pair (e.g., the JPEG file) and import the other file (e.g., RAW file) from the corresponding pair at a later time. Once the JPEG files are imported, metadata, such as user ratings, can be assigned to the imported JPEG files. Then, filter functions can be set to import a subset of all available RAW image files that match the desired metadata information. Also, when viewing the images, the JPEG, the RAW or both image files can be displayed to the user. The displayed files can be deemed to be the master file to be manipulated by the user. Also, both files in the corresponding pair can be displayed separately as two different masters. In this case, both files can be manipulated by the user separately. “Masters” can refer to the original media files imported from a camera, video recorder, memory card, computer, or external storage media. In some implementations, masters are never changed by the system, so that the original media file (e.g., an image) is preserved and can be used again. “Versions” can refer to the images or other media that is seen (and/or heard). Versions can be based on the original master, and versions can be changed, copied, and adjusted in any way.

Another example potential advantage relates to file size. Importing JPEG image files first without the corresponding RAW image files can be useful when the user doesn't have time or adequate memory space to import all of the corresponding RAW image files. The corresponding RAW images files are much larger in size than the corresponding JPEG files and thus may need a longer wait time to import. Also, these larger sized RAW image files may need a larger available storage space to import.

The subject matter described in this specification can be implemented as a method or as a system or using computer program products, tangibly embodied in computer readable medium, such as a CD-ROM, a DVD-ROM, a semiconductor memory, and a hard disk. Such computer program products may cause a data processing apparatus to conduct one or more operations described in this specification.

In addition, the subject matter described in this specification can also be implemented as a system including a processor and a memory coupled to the processor. The memory may encode one or more programs that cause the processor to perform one or more of the method acts described in this specification. Further the subject matter described in this specification can be implemented using various data processing machines.

### BRIEF DESCRIPTION OF THE DRAWINGS

FIG. 1A shows an example graphical user interface (GUI) for importing one or more media files from a data repository, such as a memory or storage device on a digital camera.

FIG. 1B shows a different state of the example GUI for presenting the available operations for importing media files.

FIG. 2A shows an example GUI that can be used to specify the modules to be used to import one or more media files from a data repository.

FIG. 2B shows an example GUI that includes the full complement of modules to be used to import one or more media files from a data repository.

FIG. 3 shows an example GUI for importing RAW+JPEG pairs.

FIG. 4 shows an example GUI that illustrates the use of metadata presets in the importation process.

FIGS. 5 and 6 are process flow diagrams showing example processes for importing media files using modules.

FIG. 7 is a block diagram of a computing device and system that can be used to implement techniques described with respect to FIGS. 1A-1B, 2A-2B, 3, 4, 5 and 6.

FIG. 8 is a block diagram of another computing device and system that can be used, e.g., to manage RAW+JPEG pairs as described with respect to FIGS. 1A-1B, 2A-2B, 3, 4, 5 and 6.

Like reference symbols and designations in the various drawings indicate like elements.

### DETAILED DESCRIPTION

Techniques, apparatus, systems and computer program product are described for specifying and using various modules during importation of media files. When the user selects the modules to use, the modules are presented as a stacked representation of the operations that will occur during the importation process. The stacked representation provides the user with a visual import pipeline, the operations of which are designated by the order of import modules displayed to the user.

One exemplary use of an import module can be for processing one or both files in a RAW+JPEG pair associated with each image file captured from a digital camera device. A user can capture an image using a digital camera, for example, and the single exposure can result in a pair of image files associated with the captured image. One file of the pair can be an image file in the raw format, which has not been processed or compressed and thus has all of the original image information available. The second file of the pair can be a processed and/or compressed image file that typically has lost some of the pixel information compared to the raw image file. One example of the corresponding pair of image files is the RAW+JPEG pair, where JPEG is a common file format technology used by digital cameras. The RAW image file can represent an unprocessed image file that retains all of the originally obtained pixel data. The JPEG image file can be a compressed image file that, as a result of the compression, has lost some of the original pixel data of the captured image.

The JPEG image file may be visibly different from the RAW image file because the JPEG image file has gone through camera processing—for example, white balance processing, data compression and the like. Further, the JPEG image file may look more saturated than the RAW image file. The JPEG image file typically can be a result of processing the RAW image by decreasing the dynamic range and performing compression. The resulting JPEG image file can be small in size and easy to work with.

The RAW+JPEG pair format can allow a user to obtain two image files from a single exposure (e.g., capturing an image) on a camera device. After shooting a RAW image file on a camera device, a corresponding JPEG image file can be generated at the same time. The RAW+JPEG pair is not obtained from two different exposures in that the shutter of the camera is not fired twice, but rather the image is captured once and saved in the two different formats.

An importation process can provide the user with the ability to selectively import the RAW and JPEG images from the pairs, either simultaneously or separately, by adjusting the import settings. The imported RAW+JPEG pairs can be displayed with the RAW, the JPEG or both image files designated as the master image file (e.g., the unmodified image before any adjustments). The designated and displayed master image file can be modified by the user.

Selecting Modules and Associated Parameters for Importation Process

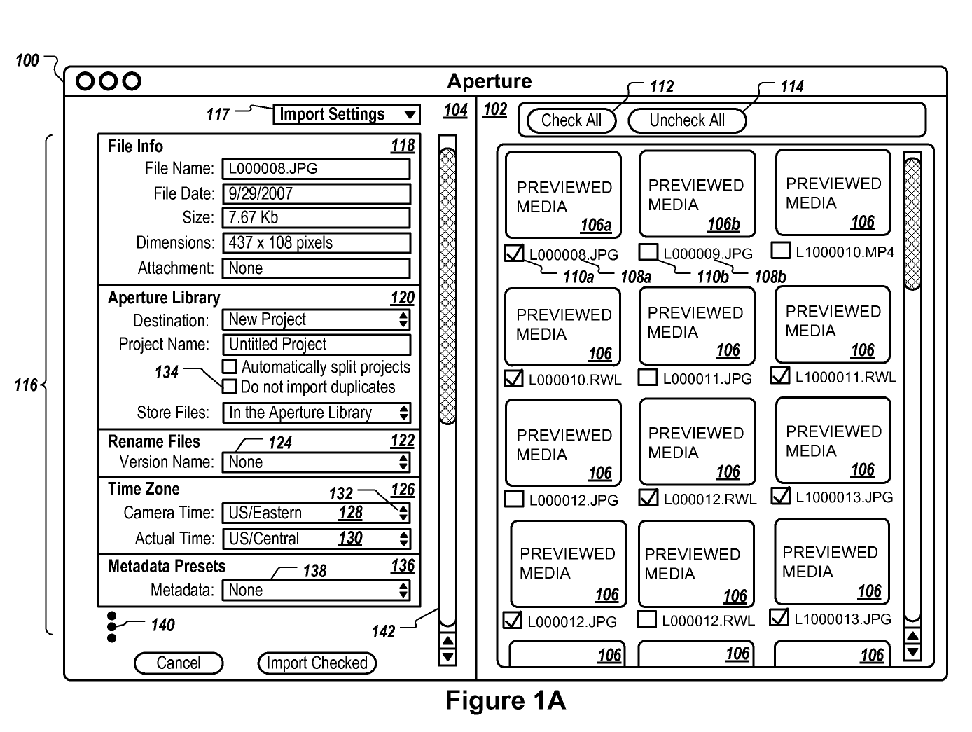

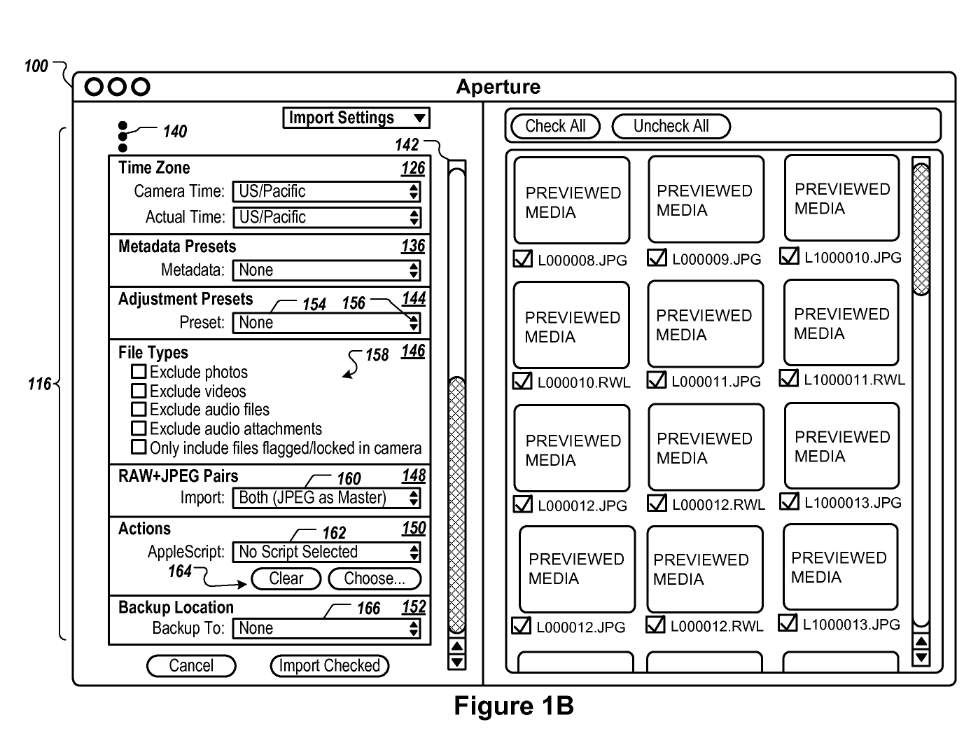

FIG. 1A shows an example graphical user interface (GUI) (100) that can be used to import one or more images from a data repository, such as from a memory or storage device on a digital or video camera. The GUI (100) includes a media preview area (102) for previewing the media files available for import. The GUI (100) further includes an import module area (104) for managing steps to be used during the subsequent process of importing media displayed in the media preview area (102). Each previewed media file (106, e.g., 106a or 106b) includes a file name (e.g., 108a or 108b) and a visual indicator (e.g., 110a or 110b) for selecting the previewed media file. The file name (e.g., 108a or 108b) displayed with the corresponding previewed media file (e.g., 106a or 106b) can indicate whether the previewed media file is a RAW image file (e.g., 106b, “RWL”), a JPEG (processed) image file (e.g., 106a, “JPG”), or any other media file format, such as an MP3, MP4, etc.

The visual indicator (e.g., 110a or 110b) for selecting the previewed media file (106) can include a user-selectable interface, such as a box that can be checked to select the corresponding media file. For example, in the example shown in the GUI (100), the visual indicator (110a) is checked for the previewed media file (106a), meaning that the subsequent importation process is to include the previewed media file (106a). By contrast, the visual indicator (110b) is unchecked for the previewed media file (106b), meaning that the subsequent importation process is to exclude (or skip) the previewed media file (106b). In some implementations, another user-selectable interface can be used to select the corresponding media file, including a radio button, a box that can be “x-ed,” a drag-and-drop interface, etc. Also, the previewed media file or the displayed file name can be highlighted to visually indicate that the corresponding media file has been selected.

The GUI (100) can also include a user interface (e.g., controls 112 and 114) for selecting or unselecting all of the previewed media files. For example, a user-selectable button (e.g., using control 112) can be implemented to automatically select (e.g., check the checkbox for) all of the previewed media files at once. Also, a user selectable button (e.g., using control 114) can be implemented to automatically unselect (e.g., uncheck the checkboxes for) all of the previewed media files at once.

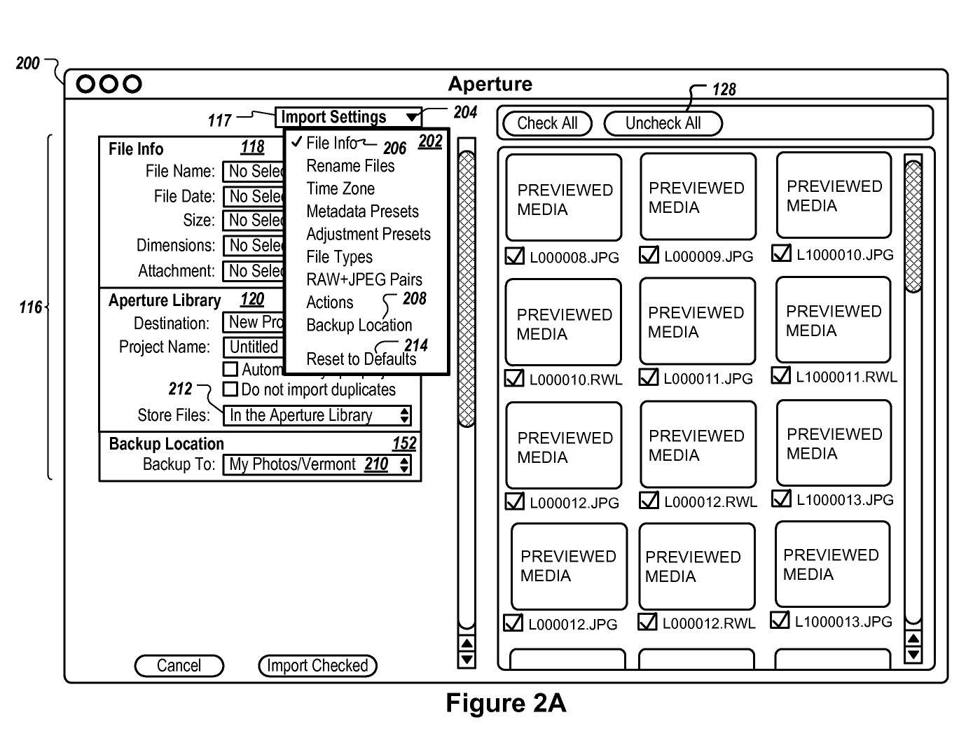

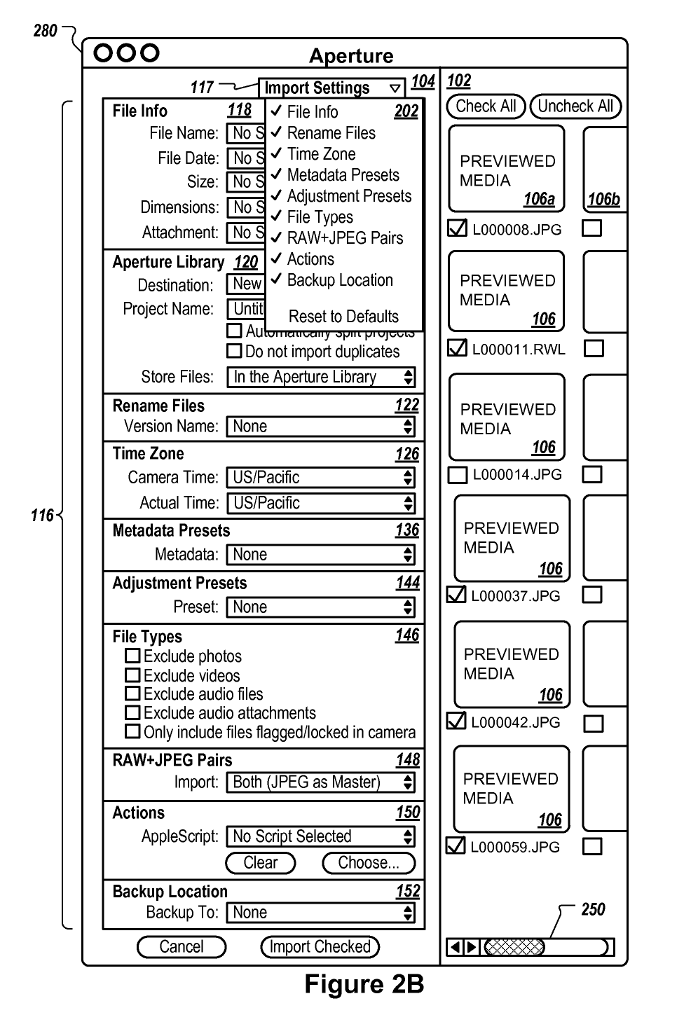

The import module area (104) can be used for adjusting the import settings used during a subsequent importation process of selected images (106, e.g., 106a). As depicted in the example GUI (100), the import module area (104) includes several modules (116) operable to control the importation process of any selected previewed media files (e.g., 106a and 106b). Modules (116) displayed and used during the importation process can be designated by the user using import settings (117), which will be described in detail with respect to FIG. 2A.

The modules (116) include a file info module (118) that can be used to display general and specific information about the previewed media files (e.g., 112, 114). For example, when a specific previewed media file (e.g., 106a or 106b) is selected, information is displayed that corresponds to the image file's file name (e.g., L00008.JPG), the file creation date, the file size (e.g., in bytes, etc.), the media dimensions (e.g., pixel dimensions for images, run-times for video, etc.), any associated attachment, or any other specific information associated with the media file. The information displayed can change, for example, whenever a different one of the previewed media files (e.g., 106a or 106b) is selected. Some or all of the information displayed in the file info module (118) can be used during the subsequent importation process to associate metadata with the media file.

A library module (120) can identify the source and destination of media files associated with the importation process, the project name associated with the media files, and any options for controlling whether projects are automatically split and how duplicate media files are handled. For example, the user can designate to store the imported files in any specific location on his computer or to a location on the Internet.

A rename files module (122) can allow the user to choose the type of naming conventions used during the importation process. As an example, if a “custom name with counter” option is selected from a version name field (124), the importation process can automatically name imported media files based on the information supplied. For instance, the user can enter “Vermont Vacation” as the custom name, or “Vermont Vacation” can be the name of a project defined to the system. As a result, media files imported can be named with the prefix “Vermont Vacation nnn” where nnn ranges from “001” to the highest sequentially-numbered media file to be imported. Other name formats available as selectable options from the version name field (124) can allow the user to create a variety of custom name formats, including formats that include the date or identify the type of media, to name a few examples.

In some implementations, modules (116) can change in size, such as in the vertical direction, when selections are made or data is input into each module (116). For example, while the vertical size of the rename files module (122) can be relatively small when the version name field (124) is set to “None,” the rename files module (122) can automatically grow in size if particular values are input (or selected for) the version name field (124). In a specific example, if the “custom name with counter” option is selected for the version name field (124), the box surrounding the rename files module (122) can grow to accommodate the additional fields and other controls associated with that selection. Similarly, the size of any particular modules (116) can decrease based on user inputs, such as selecting an option which has fewer associated fields and/or controls that a previously selected option. In some implementations, the size of a module (116) can be reduced by the user, such as by selecting a reduce or minimize control to hide information not needed for a current display. A restore or maximize control can be used to restore a module (116) to its full size. As any one module (116) changes in size, other modules (116) can be automatically shifted up or down accordingly in order to maintain a display of stacked modules (116).

A time zone module (126) can allow the user to specify the time zones associated with the location in which the media files were created (e.g., during a Vermont vacation in the Eastern Time Zone) versus where the importation process is to be executed (e.g., back home in Nebraska in the Central Time Zone). For instance, the user can specify “US/Eastern” (e.g., for Vermont) in a camera time field (128) and “US/Central” (e.g., for Nebraska) in an actual time field (130). In general, user entry into fields and other controls can be made by typing in values or by using selection lists having pre-set values. For example, “US/Eastern” and “US/Central” can be user-selectable options available for selection of several time zones that appear in a list when the user selects a select-list control (132). Other fields in other modules (116) can have other types of controls, including radio buttons, checkboxes (134) or other controls. When the time zone module (126) is used, time-based metadata associated with media files can be automatically shifted by the time difference between the camera time field (128) and the actual time field (130).

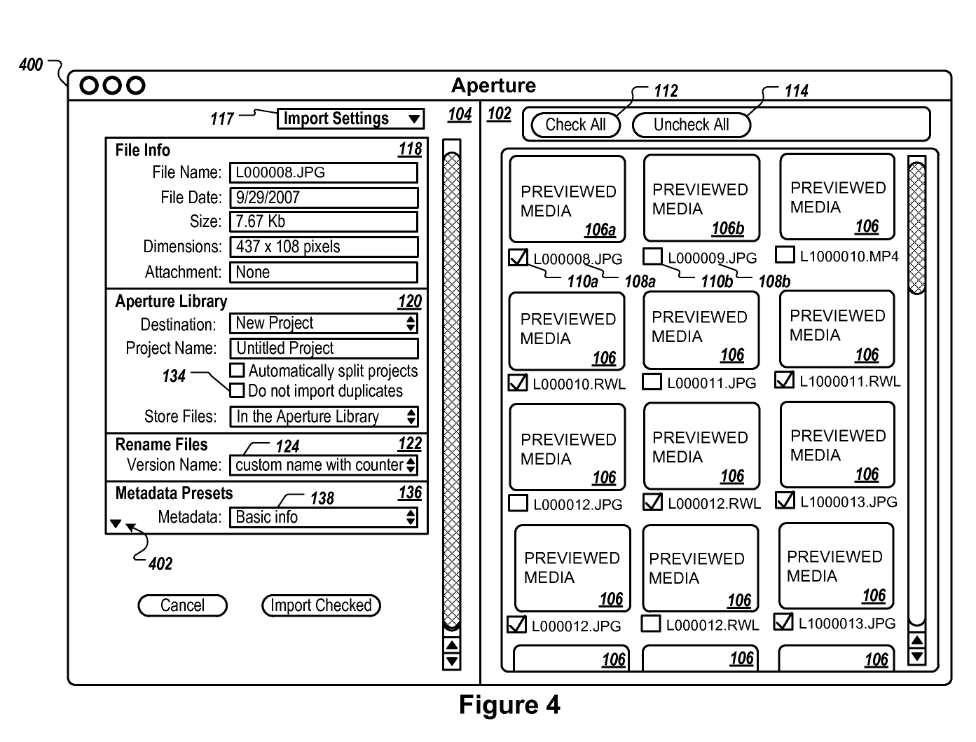

A metadata presets module (136) allows the user to manage the pre-set fields used in associating metadata with each media file imported. As shown in FIG. 1A, the current selection for a metadata field (138) is “None.” However, as will be described in more detail below with respect to FIG. 4, selecting other values for the metadata field (138) (e.g., “Basic Info”) can allow the user to define captions, keywords, image location (e.g., city, state/province, country, etc.), copyright notice, credits, etc. associated with the imported media files.

The modules (116) include other modules not shown on FIG. 1A, as indicated by ellipses (140). The user can use a scroll bar (142) to display and access other modules (e.g., as described with respect to FIG. 1B). In some implementations, when all modules (116) displayed and in use are few enough in number to fit as a group on the screen, the scroll bar (142) is not displayed or is otherwise hidden or deactivated. If additional modules (142) are added to the display, the scroll bar (142) can re-appear and/or become active, in order to access modules (116) that are scrolled off the screen.

FIG. 1B shows a different state of the example GUI (100) for presenting the available operations for importing media files. The modules (116) that are scrolled off of the display in FIG. 1A are shown here and include additional modules (e.g., 144 through 152). In this state of the GUI (100), the ellipses (140) appear at the top, indicating additional modules (116) not seen in the display. Furthermore, the scroll bar (142) is in a different state, scrolled fully to the bottom. In some implementations, additional controls and displays can exist to indicate the presence of (and to navigate to) other modules (116). For instance, ellipses (140) can appear at the top and bottom of the display, indicating that the modules (116) being display are somewhere in the middle of the collection of modules (116). This condition can occur, for example, if several modules (116) are selected and active, and individual selections on the modules (116) have caused the vertical size of the modules (116) to increase.

The adjustment presets module (144) can allow the user to select a named adjustment preset to cause automatic adjustments to media during the importation process. By specifying the name of an existing adjustment preset in a preset name field (154), the importation process can apply the corresponding media adjustments such as black and white conversions, contrast, cross-processing, tinting, high-key, landscape/portrait cropping, or any other adjustments that have been defined earlier and associated with a preset name. The user can select a present name, for instance, using a control 156 to display and select from a list of pre-defined adjustment presets. In some implementations, additional controls can exist to navigate to one or more GUI screens for defining new adjustment presets or for displaying or modifying existing ones.

In some implementations, multiple adjustment presets module (144) can be used, such as to apply, during the importation process, separately-named exposure adjustments, color adjustments or other adjustments at the same time. To facilitate multiple adjustments in this case, additional controls can be added to the user interface for selecting multiple instances of modules, as will be described in detail below with respect to FIG. 2A.

Fields and controls in the adjustment presets module (144) can include histograms or other displays depicting the current settings, and sliders or other controls for making adjustments. A straighten adjustment, for example, can allow the user to slightly turn and straighten images using a user-defined rotation angle. A white balance control can include sliding controls for adjusting temp and tint. Exposure adjustment controls can include sliding controls that allow the user to adjust exposure, recovery, black point and brightness. Enhancement controls can allow the user to adjust contrast, definition, saturation and vibrancy. Other controls can allow the user to make adjustments to tint settings, color levels (e.g., luminance, RGB, or Red, Green and Blue individually), highlights and shadows.

In some implementations, adjustment settings can be used to adjust the audio portions of media, such as in MP3, MP4, or other media formats having sound. In some implementations, modules associated with sound can be automatically defaulted to “on,” for example, if the system determines that audio-related media files are present.

Also, the JPEG and RAW image files may have different height and width information. Thus, when applying the different image adjustment to the JPEG and RAW image files, these differences in the height and width of the media files can be compensated using a corrective relative spatial location determination. For example, when the color of a jacket worn by a person in the JPEG image file is adjusted, the pixel location of the jacket can be different in the RAW image file. Thus, the relative location of the jacket with respect to a reference point can be calculated in the JPEG image file and extrapolated onto the RAW image file. For example, the jacket location can be calculated from the center of the JPEG image or from the edges of the JPEG image or both. Other spatial corrective techniques can be used to determine the correct location of the image adjustment.

The user may be presented with the control over which image adjustments carry over to both the JPEG and RAW image files. Also, the applied adjustments are removable or non-destructive. Rather than directly modifying the pixel information of the media files, a record or file can be generated with the desired image adjustment information. In this way, “masters” are preserved while “versions” are created that are derived (e.g., using adjustments, etc.) from the masters or other versions. The record with the desired image adjustment is associated with the corresponding media files, such that when either or both media files are displayed, the image adjustment information from the image adjustment file is used to apply the image adjustment to the displayed image(s).

The file types module (146) can allow the user to specify certain types of files to skip during the importation process. For example, by checking the checkboxes (158) provided, the user can exclude photos, videos, audio files and/or audio attachments. Another parameter in the file types module (146) can allow the user to import only those media files that are flagged or locked in camera.

The RAW+JPG pairs module (148) can provide different user options for importing the RAW+JPEG pairs. Import setting (160) can be adjusted, for example, to import both the RAW image file and the JPEG image file together with the JPEG image file designated as the master media file. In some cases, when the user wants to simply import JPEG files without the RAW files, the user can select or specify “JPEG files only” for the import setting (160). Otherwise, if the user enters “Matching RAW Files” as the option in the import setting field (160), an additional “include” field is displayed, from which the user can select options such as “All Matching Files,” “Unrated or Better” or “Current Filter” to name a few examples.

The master media file is displayed to the user, and the user can apply adjustments, metadata, etc. to the master media file. By adjusting the import settings, both the RAW image file and the JPEG image file from the corresponding RAW+JPEG pair can be imported together with the RAW image file as the master. The import settings can be adjusted to import the JPEG image file from the selected RAW+JPEG pair(s) without importing the corresponding RAW image file. Also, the import settings can be adjusted to import the RAW image file from the selected RAW+JPEG pair(s) without importing the corresponding JPEG image file. In addition, the import settings can be adjusted to import both the RAW image file and the corresponding JPEG image file together with each media file designated as a separate master file. When the two media files in the corresponding RAW+JPEG pair are linked together, either one of the two files can be selected as the master file. For example, the import settings can be adjusted to import both files with the JPEG image file selected as the master file. Alternatively, the import settings can be adjusted to import both media files with the RAW image file selected as the master file.

When one of the two media files from the corresponding RAW+JPEG pair is selected and displayed as the master file, the other file in the corresponding RAW+JPEG pair is not visible to the user. However, the user can easily switch between the two files in the corresponding RAW+JPEG pair as the master file.

The actions module (150) can allow the user to designate a particular script or macro to run during the importation process. For example, using an “AppleScript” field (162), the user can type in the name of an AppleScript or other macro, or select one from a pull-down list. In some implementations, additional controls can exist, for example, that allow the user to browse or search for specific script or macro files on the computer. Once a macro is identified, the user can select one of the controls (164), such as to clear existing user-defined values in the fields of the actions module (150) or to choose a different AppleScript program to run during the importation process.

The backup location module (152) can allow the user to specify parameters used in automatically copying media files to designated backup locations. For example, the user can specify a backup location on his computer.

In some implementations, the position of the backup location module (152) relative to other modules (116) can be controlled by the user. For example, using a drag-and-drop feature or by settings in configuration settings (not shown in FIG. 1B) the user can move the backup location module (152) higher in the sequence, thus causing the backup location module (152) to run sooner in the sequence of modules (116). In some implementations, multiple backup location modules (152) can exist, such as to allow the user to back up media files before they are modified by the importation process, and again at or near the end of the importation process.

FIG. 2A shows an example graphical user interface (GUI) (200) that can be used to specify the modules to be used to import one or more media files from a data repository, such as from a memory or storage device on a digital or video camera, or from a folder on a computer or a web site, etc. For example, the GUI (200) includes a modules selection list (202) that lists the modules that the user can select to control the importation process. The user can select the drop-down control (204), for example, on the import settings (117) to display the modules selection list (202). The modules (116) displayed in the GUIs (e.g., 100 and 200) can depend, for example, on which modules are selected from the modules selection list (202). As an example, the file info module (118) is displayed because file info option (206) is currently checked. In some implementations, the user can create customized modules, including modules based on downloads from 3rd parties. For example, the GUI (200) can include a download tool (not shown) that the user can use to access any 3rd party's available modules. The user can further select one of the modules for download onto his computer. Subsequent display of the modules selection list (202) can include the 3rd party module. The user can add the 3rd party module to his vertical stack of modules, for example, by checking the option modules selection list (202).

Default selections can exist for the GUI (200). For example, upon entry to the GUI (200), the file info option (206) can be checked initially by default, and as a result, the file info module (118) is also displayed by default. Displaying the file info module (118) can provide the advantage of allowing the user to browse media files one-by-one in order to select (or deselect) particular media files to be imported. During the process, the information in the fields within the file info module (118) can change, depending on the media file currently selected by the user.

Another default on the GUI (200) can be the library module (120) which can identify the source and destination of the media files to be imported. The library module (120) can be one of the modules (116) for which no user-selectable entry exists in the modules selection list (202), as this type of information typically applies to all importation processes. In some implementations, the details of the library module (120) can be hidden, while still displaying the top portion the library module (120), for example. In this way, the user can concentrate on the import settings that are more of interest to the user.

In some implementations, default settings included in the modules selection list (202) can be user-configurable and/or automatically determined by the system. As an example, the user may always want to back up media files as a last step during every importation process. For convenience, some implementations can allow users to specify defaults, such as a check-box configuration setting that says, “Always show Backup Location module” or other control(s) with the same result. As a result of the user defining that type of setting, a backup location option (208) can be checked initially when the user first sees another instance of the GUI (200). Moreover, the corresponding backup location module (152) is automatically displayed, and the user can specify “My Photos/Vermont” or some other location in a “Backup To” field 210. As a result, during the importation process, for example, media files that are imported to a “Store Files” location 212 can also be backed up in the user's “My Photos/Vermont” folder.

In some implementations, the GUI (200) can include a “Reset to Defaults” option (214), which the user can select to restore the original settings on the modules selection list (202). The original settings can include the defaults determined by the GUI (200), including settings for modules (116) that are typically always displayed, any modules pre-specified by the user to be displayed by default, and modules determined automatically by the system as “needed” because of the type of media files currently identified for subsequent import. In some implementations, other default-restoring controls can exist in addition to the “Reset to Defaults” option (214), such as “Reset to User Defaults” or “Reset to Content-Based” options, each restoring modules settings based on user settings or the types of media to be imported, respectively.

In some implementations, in addition to checkmarks for selecting individual options in the modules selection list (202), additional controls can exist that allow the selection of multiple instances of certain modules. For example, in some implementations, the user can select two separate instances of the backup location module, such as to backup unmodified images to one location, and then backing up the adjusted images to a second location.

FIG. 2B shows an example GUI (280) that shows the full complement of modules available for use when importing one or more media files from a data repository. In this example, all user-selectable options in the modules selection list (202) are checked. As a result, all possible modules (116) are displayed in the import module area (104). In this example configuration of the GUI (280), part of the information in the media preview area (102) is scrolled off the screen, but the user can access the information using a scroll control (250). The user may choose to display this arrangement of information, for example, in order to see all of the modules (116) simultaneously on one screen.

Importing Corresponding Raw Files Using First Imported JPEG Files

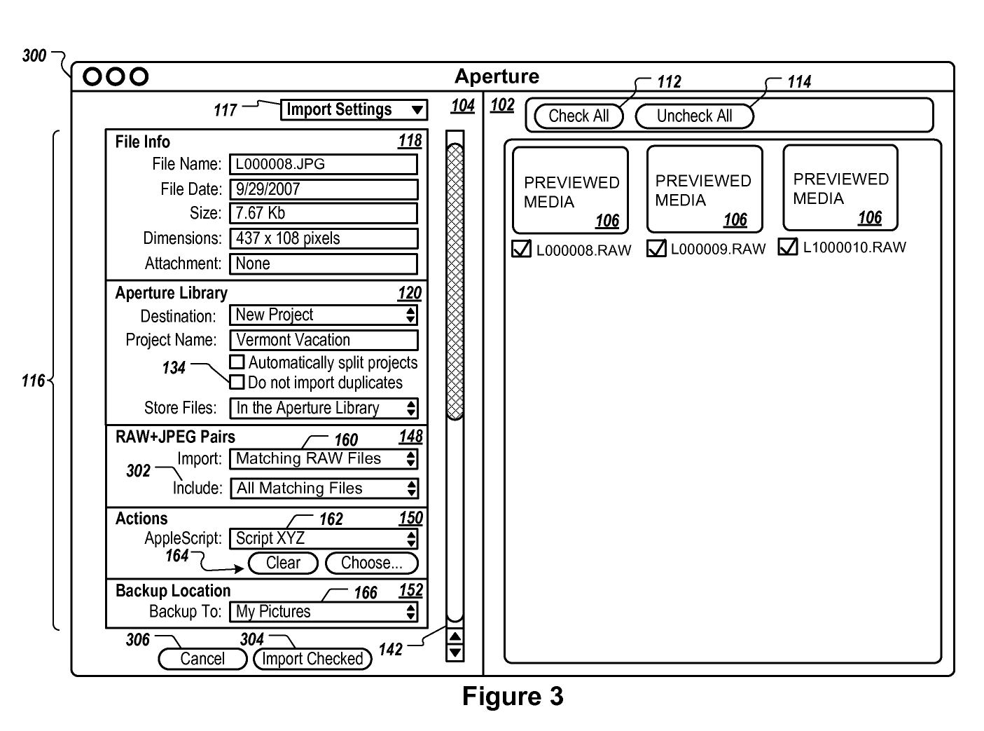

FIG. 3 shows an example GUI (300) that can be used for importing selected media files from RAW+JPEG pairs. For example, if in a previous importation process, JPEG image files alone were imported, the settings in the GUI (300) can be used to import any available corresponding RAW image files. The import settings (117) are defined to display and use the file info module (118), the library module (120), the RAW+JPEG pairs module (148), the actions module (150), and the backup location module (152).

Within the RAW+JPEG pairs module (148), the import setting (160) is set to “Matching RAW Files” and an include setting (302) is set to “All Matching Files.” In this example using these settings, for any JPEG files were imported earlier, the matching RAW files are also imported at this time. In response to the request to import all matching RAW image files including all matching files, the corresponding RAW image files corresponding to previously-imported JPEG image files can be displayed in the preview area (102) of the GUI (300)

In general, the import file-type setting (132) can be selected by the user to import all matching or corresponding RAW image files (or JPEG files when RAW files are imported first), either in pairs or one at a time. For example, rather than importing both files in the corresponding RAW+JPEG pair, one of the two files can be imported first. The RAW image files are larger in size than the corresponding JPEG files, and thus it may be more efficient, with respect to time and storage space, to import the JPEG files first without the RAW files. From the imported JPEG files, a select number of corresponding RAW image files can be imported. This process can eliminate the need to import all of the RAW image files at the beginning.

As described above, the selected master file(s) from the corresponding RAW+JPEG pair can be displayed to the user, and the user can apply the desired metadata or adjustments to the displayed master file(s). If the applied metadata and adjustments are identified as those that should be associated with the other media file, the metadata and adjustments can be automatically associated with the other media file in the corresponding RAW+JPEG pair. Also, when the RAW media file is linked to the JPEG image file, the applied metadata and adjustments can be automatically associated with the other media file in the corresponding RAW+JPEG pair.

Visual indicators used to identify files in pairs, such as RAW+JPEG pairs, can appear as file name extensions or suffixes (e.g., JPEG, JPG, RAW, RWL, etc.) displayed in the media preview area (102). Also, the visual indicator is not limited to textual information and can include non-textual information, such as different shaped objects, different colored objects, etc.

When the user has completed his input, including previewing media in the preview media area (102), using the import settings (117) to select modules (116), and providing selections and/or values for fields and parameters in the modules (116), the user can select a control (304) to initiate the importation process. As the importation process executes, operations based on information from the modules (116) can be executed in the order that the modules (116) are displayed. If for some reason the user decides not to import media files, the user can select a control (306) to cancel the importation process.

During the subsequent importation process using the import settings on the GUI (300), matching RAW files (e.g., as designated by the import setting 160), including all matching files (e.g., as designated by the include setting 302) are imported. As each media file is imported (or in some implementations, as a group), the script “ScriptXYZ” (e.g., as designated in the AppleScript 162 setting) is applied. Imported files, in addition to being stored in the location designated, are also backed up to the user's “My Pictures” folder (e.g., as designated in the “Backup To” field 166).

Associating Metadata with Imported Media

FIG. 4 shows an example GUI (400) that can be used for importing selected media files using information from the metadata presets module (136). During the subsequent importation process using the import setting on the GUI (400), imported media files can be renamed according to the settings in the rename files module (122). Specifically, because the “custom name with counter” option is selected as the version name (124), each file stored as a result of the importation process is assigned a common prefix (e.g., “Vermont_Vacation”) and a unique counter-based suffix (e.g., 001, 002, etc.) in the file name. Moreover, metadata presets are applied to the media files, as determined by user settings in the metadata presets module (136). For example, if the “Basic Info” option is selected for the metadata field (138), user settings for captions, keywords, image location (e.g., city, state/province, country, etc.), copyright notice, credits, etc. are associated with the imported media files. A control (402) can be used to hide such fields in the metadata presets module (136), for example, if the user is familiar with the information normally associated with “Basic Info” and need not review his current settings.

Process Flows for Importing Media

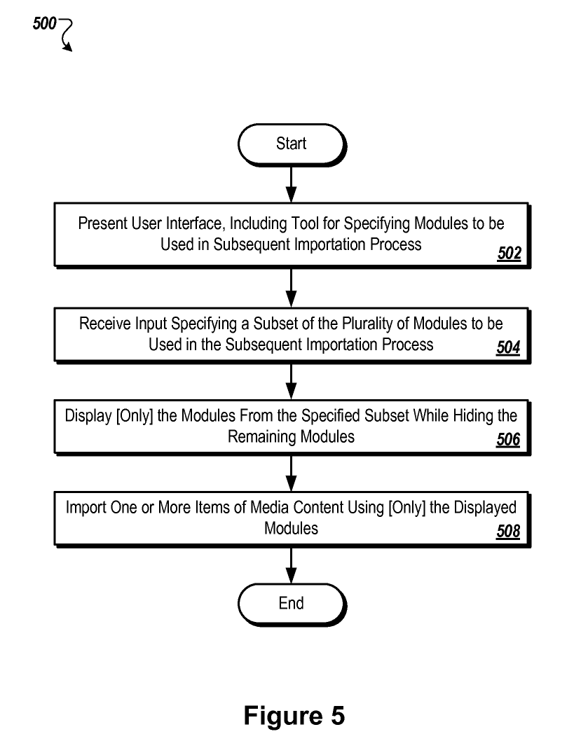

FIG. 5 is a process flow diagram showing an example process 500 for importing media files using modules. A system or apparatus can implement a GUI (e.g., 100, 200, 280, 300 and 400) to present a user interface, including a tool for specifying modules to be used during the importation process (502). For example, the user interface can be the GUI (200). The user tool can include the modules selection list (202) and the modules (116) that are displayed as a result.

Input is received specifying a subset of modules to be used in the subsequent importation process (504). As an example, using the modules selection list (202), the user can make selections of modules to be used by checking to turn on (and un-checking to turn off) specific modules, such as the file info option (206), the backup location option (208), or other options in the modules selection list (202).

The system displays only those modules specified, while hiding the remaining modules (506). For example, depending on the options selected in the modules selection list (202), the corresponding modules (116) can be displayed. Specifically, if the file info option (206) is currently checked, then the file info module (118) is displayed. At the same time, any modules (116) not currently displayed remain hidden because the corresponding option in the modules selection list (202) is not checked (or otherwise selected). As an example, the time zone module (126) remains hidden because the corresponding option in the modules selection list (202) is not checked.

During the subsequent importation process, one or more media content items are imported using only the displayed modules (508). For example, as shown in FIG. 2, the only modules (116) that affect the import process are the file info module (118), library module (120) and backup location module (152).

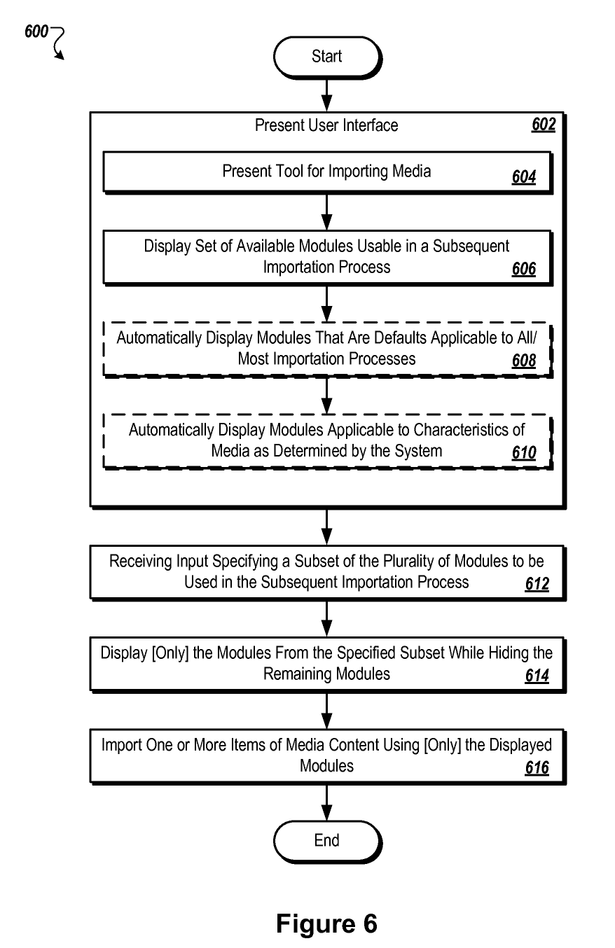

FIG. 6 is a process flow diagram showing an example process 600 for importing media files using modules. A system or apparatus can implement a GUI (e.g., 100, 200, 280, 300 and 400) to present a user interface (602). For example, the user interface can be the GUI (200). Presenting the user interface includes presenting a tool for specifying modules to be used during the importation process (604). For example, the user tool can include the modules selection list (202) and the modules (116) that are displayed as a result. Presenting the user interface further includes displaying a set of available modules that can be used for a subsequent importation process (606). For example, the available modules can be presented in the modules selection list (202).

In some implementations, default modules are optionally displayed (608). The default modules correspond to modules that are typically used in all or most importation processes. For example, the file info module (118) can be displayed by default each time the modules (116) are displayed.

In some implementations, modules are optionally displayed that correspond to automatically-detected types of media based on, for example, characteristics of the media (610). For example, when the images in the preview images area (102) include any parts of a RAW+JPG pair, the system can automatically display RAW+JPG pairs module (148) as a “suggested” or “required” module. As a result, the RAW+JPG pairs module (148) can appear automatically in its position among the other modules (116).

Input is received specifying a subset of modules to be used in the subsequent importation process (612). As an example, using the modules selection list (202), the user can make selections of modules to be used by checking to turn on (and un-checking to turn off) specific modules, such as the file info option (206), the backup location option (208), or other options in the modules selection list (202).

The system displays only those modules specified, while hiding the remaining modules (614). For example, depending on the options selected in the modules selection list (202), the corresponding modules (116) can be displayed. Specifically, if the file info option (206) is currently checked, then the file info module (118) is displayed. At the same time, any modules (116) not currently displayed remain hidden because the corresponding option in the modules selection list (202) is not checked (or otherwise selected). As an example, the time zone module (126) remains hidden because the corresponding option in the modules selection list (202) is not checked.

During the subsequent importation process, one or more media content items are imported using only the displayed modules (616). For example, as shown in FIG. 2, the only modules (116) that affect the import process are the file info module (118), library module (120) and backup location module (152).

In some implementations, GUIs similar to GUIs described above (e.g., 100, 200, 280, 300 and 400) can be used for exporting media, or for transferring media files from location to another while performing various module-based operations. In this case, the types, names and functions of the module can differ extensively from the modules (106) used in importation processes.

All import options described in this specification with respect to importing still images and video images apply to importing digital audio files.

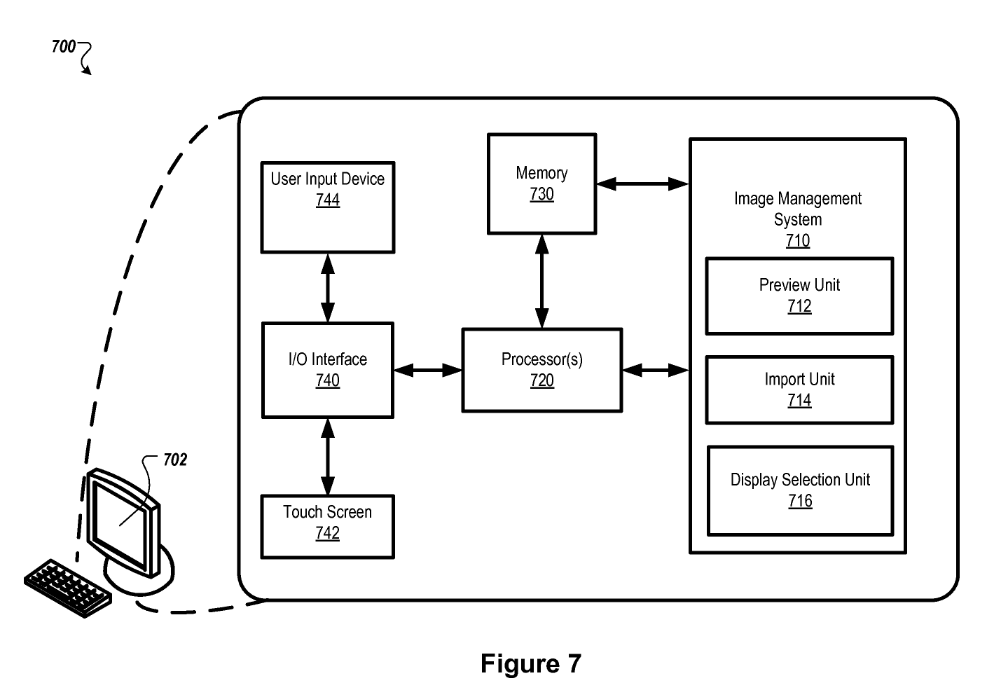

FIG. 7 is a block diagram of a computing device and system (700) that can be used to implement the techniques described with respect to FIGS. 1A-1B, 3A-3E, 4, 5 and 6. The system (700) can include a processor (720) to control operation of the system (700) including executing any machine or computer readable instructions. The processor (720) can communicate with a memory or data storage unit (730) that can store data, such as media files and machine or computer readable instructions. Also, the processor (720) can communicate with an image management system (710) to manage different media files including import, export, storage, image adjustment, metadata application and display of the media files. The processor (720) can communicate with an input/output (I/O) interface (740) that can interface with different input devices, output devices or both. For example, the I/O interface (740) can interface with a touch screen (742) on a display device (702). Also, the I/O interface (740) can interface with a user input device (744) such as a keyboard, a mouse, a trackball, etc. that are designed to receive input form a user.

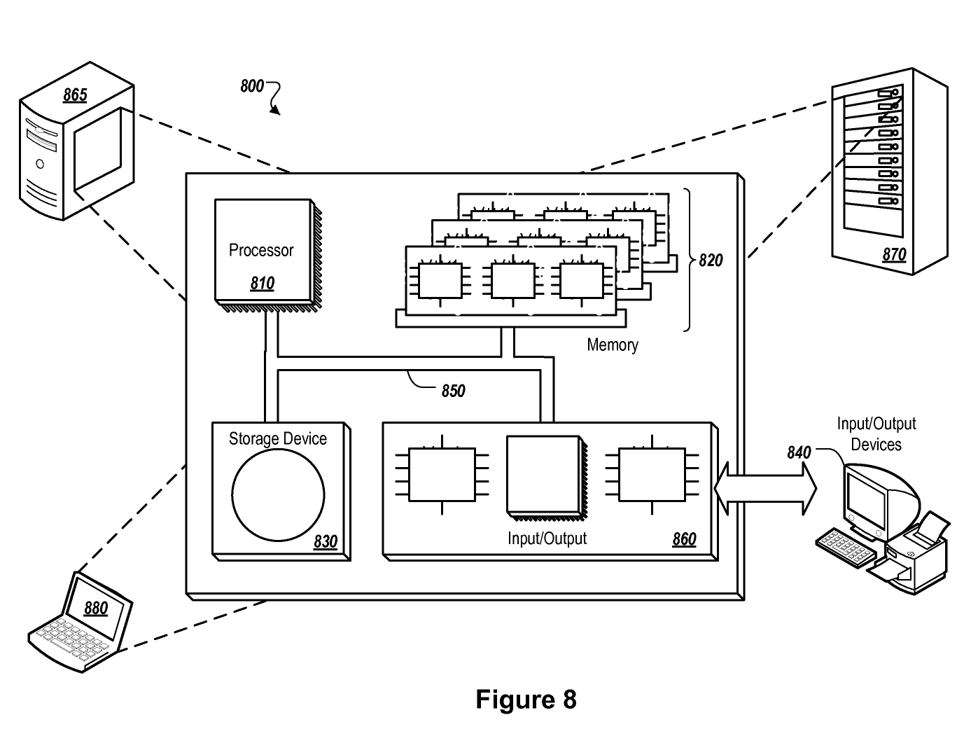

FIG. 8 is a block diagram of another computing device and system that can be used, e.g., to manage RAW+JPEG pairs as described with respect to FIGS. 1A-1B, 3A-3E, 4, 5 and 6. Computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 800 includes a processor 810, memory 820, a storage device 830, a high-speed interface 850 connecting to memory 820. The computing device can also include high-speed expansion ports (not shown), and a low speed interface (not shown) connecting to low speed bus (not shown) and storage device 830. Each of the components 810, 820, 830, 850, and 820, are interconnected using various busses, and can be mounted on a common motherboard or in other manners as appropriate. The processor 810 can process instructions for execution within the computing device 800, including instructions stored in the memory 820 or on the storage device 830 to display graphical information for a GUI on an external input/output device, such as display 840 coupled to an input/output interface 860. In other implementations, multiple processors and/or multiple buses can be used, as appropriate, along with multiple memories and types of memory. Also, multiple computing devices 800 can be connected, with each device providing portions of the necessary operations (e.g., as a server bank, a group of blade servers, or a multi-processor system).

The memory 820 stores information within the computing device 800. In one implementation, the memory 820 is a computer-readable medium. In one implementation, the memory 820 is a volatile memory unit or units. In another implementation, the memory 820 is a non-volatile memory unit or units.

The storage device 830 is capable of providing mass storage for the computing device 800. In one implementation, the storage device 830 is a computer-readable medium. In various different implementations, the storage device 830 can be a floppy disk device, a hard disk device, an optical disk device, or a tape device, a flash memory or other similar solid state memory device, or an array of devices, including devices in a storage area network or other configurations. The computer program product contains instructions that, when executed, perform one or more methods, such as those described above. The computer- or machine-readable medium can include the memory 820, the storage device 830, memory on processor 810, or a propagated signal.

The high speed controller 850 manages bandwidth-intensive operations for the computing device 800, while the low speed controller manages lower bandwidth-intensive operations. Such allocation of duties is exemplary only. In one implementation, the high-speed controller 850 is coupled to memory 820, display 840 (e.g., through a graphics processor or accelerator), and to high-speed expansion ports (not shown), which can accept various expansion cards (not shown). In the implementation, low-speed controller (not shown) is coupled to storage device 830 and low-speed expansion port (not shown). The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 800 can be implemented in a number of different forms, as shown in the figure. For example, it can be implemented as a standard server 865, or multiple times in a group of such servers. It can also be implemented as part of a rack server system 870. In addition, it can be implemented in a personal computer such as a laptop computer 880.

Implementations of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible computer or machine readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Only a few implementations and examples are described and other implementations, enhancements and variations can be made based on what is described and illustrated in this application. For example, the GUIs 100, 200, 280 300 and 400 may be implemented as the same GUI or as separate GUIs. Also, any number of the GUIs can be implemented together.

A number of embodiments have been described. Nevertheless, it will be understood that various modifications are optionally made without departing from the spirit and scope of this disclosure. Accordingly, other embodiments are within the scope of the following claims.

What is claimed is:

1. A method performed by a media manipulation software application executing on a computer system, the method comprising:
presenting a user interface for the media manipulation software application, the user interface including an import tool configured to facilitate importation of one or more items of media content into the media manipulation software application, the import tool having a plurality of modules, each module representing a different aspect of an importation process;
receiving input specifying a subset of the plurality of modules, each module in the specified subset to be displayed to the user and to be used in a subsequent importation process;
displaying to the user the modules from the specified subset while hiding the remaining modules from the user; and
importing one or more items of media content using the displayed modules.

2. The method of claim 1 wherein the media comprises one or more of digital still images, digital video and digital audio.

3. The method of claim 1 wherein the modules are arranged in an order-dependent manner.

4. The method of claim 1 wherein the modules are arranged vertically wherein a topmost module corresponds to a start of an importation pipeline and a bottommost module corresponds to an end of the importation pipeline.

5. The method of claim 1 wherein modules are displayed as vertically-stacked bricks along an edge of the user interface.

6. The method of claim 1 wherein each module comprises one or more importation parameters.

7. The method of claim 1 wherein the modules comprise a file information module for displaying information about media files, including file name, file date, file size and media dimensions.

8. The method of claim 1 wherein the modules comprise a library module for specifying the source, destination and handling of imported media files.

9. The method of claim 1 wherein the modules comprise a rename files module for controlling naming conventions of media files, including one or both of file name prefixes and counters, for creating custom names for media files.

10. The method of claim 1 wherein the modules comprise a time zone module for specifying time zones associated with the media creation location or importation location or both.

11. The method of claim 1 wherein the modules comprise a metadata presets module for specifying fields used in associating metadata with each media file imported, including one or more of captions, keywords, image geographic source, copyright notice and credits.

12. The method of claim 1 wherein the modules comprise an adjustment presets module for applying media adjustments including one or more of black and white conversions, contrast, cross-processing, tinting, cropping, and high-key.

13. The method of claim 1 wherein the modules comprise a file types module for specifying which media file types to include or exclude during the importation process.

14. The method of claim 1 wherein the modules comprise a RAW+JPG pairs module that provides one or more options for importing the RAW+JPEG pairs.

15. The method of claim 1 wherein the modules comprise an actions module for designating a specified macro to run during the importation process.

16. The method of claim 1 wherein the modules comprise a backup location module for specifying parameters used in automatically copying media files to designated locations.

17. The method of claim 1 wherein one or more modules are displayed and used automatically without requiring further user input.

18. The method of claim 1 further comprising enabling the user to specify one or more customized modules to be displayed and used in the importation process.

19. The method of claim 18 wherein user specified modules are downloaded from a network location corresponding to a third party developer.

20. The method of claim 1 further comprising enabling the user to selectively change an order of the modules.

21. The method of claim 1 wherein the receiving input specifying a subset of the plurality of modules comprises receiving input from the user.

22. The method of claim 1 wherein receiving input specifying a subset of the plurality of modules comprises receiving input from an auto-detection software process.

23. A system comprising:
a computer system having a processor, memory and input/output functionality;
a media manipulation application configured to execute on the computer system and further configured to facilitate importation of selected media, wherein the media manipulation application comprises:
a user interface that includes an import tool configured to facilitate importation of one or more items of media content into the media manipulation application, the import tool having a plurality of modules, each module representing a different aspect of an importation process;
a module selection unit to select the modules to be used in the importation process;
a user input unit to communicate with the media manipulation application, wherein the user input unit is configured to receive a selection of at least one of the modules and a selection of at least one of the available media; and
a display unit to communicate with the media manipulation application, wherein the display unit is configured to display the media selected for the importation process and the modules selected for the importation process based on the received selection.

24. A computer-readable medium encoded with a computer program, the computer program comprising instructions that when executed by a processor of a computing device cause the processor to perform operations comprising:
present a user interface for the media manipulation software application, the user interface including an import tool configured to facilitate importation of one or more items of media content into the media manipulation software application, the import tool having a plurality of modules, each module representing a different aspect of an importation process;
receive input specifying a subset of the plurality of modules, each module in the specified subset to be displayed to the user and to be used in a subsequent importation process;
display to the user the modules from the specified subset while hiding the remaining modules from the user; and
import one or more items of media content using the displayed modules.
